(19) United States
(12) Patent Application Publication
(10) Pub. No.: US 2025/0298851 A1
(43) Pub. Date: Sep. 25, 2025

(54) USER INTERFACE NAVIGATION FOR WEB APPLICATIONS WITH RETRIEVAL-AUGMENTED GENERATION

(71) Applicant: Palo Alto Networks, Inc., Santa Clara, CA (US)

(72) Inventors: Adithya Patham Shriram, San Jose, CA (US); Alok Tongaonkar, San Jose, CA (US)

(21) Appl. No.: 18/614,920

(22) Filed: Mar. 25, 2024

(51) Int. Cl. G06F 16/953

(52) U.S. Cl. CPC G06F 16/953

(57) ABSTRACT

An offline collection system comprises a pipeline for storing metadata of user interface (UI) elements at web pages of a web application. The pipeline comprises crawling uniform resource locators (URLs) of web pages of the web application for content and rendering screenshots of the web pages. The pipeline then prompts a multimodal large language model (LLM) to generate database entries for the web pages comprising UI element metadata derived from the crawled content and rendered screenshots. A response system receives user queries to navigate the web application and augments prompts to an LLM to respond to the user queries with metadata of UI elements relevant to the user queries stored by the offline collection system.

### BACKGROUND

The disclosure generally relates to data processing (e.g., CPC subclass G06F) and to computing arrangements based on specific computational models (e.g., CPC subclass G06N).

Chatbots are commonly employed to provide automated assistance to users by simulating human conversation via chat-based interactions. Example use cases for chatbots include handling customer inquiries, automating tasks, providing information, and delivering recommendations. Chatbots are increasingly implemented using artificial intelligence (AI) to handle and respond to natural language inputs from users, with implementations rapidly adopting generative AI for text generation.

Large language models (LLMs) are implemented as chatbots to respond to user queries based on prompts generated from engineered templates. For LLMs, the meaning of model training has expanded to encompass pre-training and fine-tuning. In pre-training, the LLM is trained on a large training dataset for the general task of generating an output sequence based on predicting a next sequence of tokens. In fine-tuning, various techniques are used to fine-tune the training of the pre-trained LLM to a particular task. For instance, a training dataset of examples that pair prompts and responses/predictions are input into a pre-trained LLM to fine-tune it. Prompt-tuning and prompt engineering of LLMs have also been introduced as lightweight alternatives to fine-tuning. Prompt engineering can be leveraged when a smaller dataset is available for tailoring an LLM to a particular task (e.g., via few-shot prompting) or when limited computing resources are available. In prompt engineering, additional context may be fed to the LLM in prompts that guide the LLM as to the desired outputs for the task without retraining the entire LLM.

Retrieval-augmented generation (RAG) is a technique that boosts data inputs to LLMs by retrieving data outside the scope of raw inputs (e.g., user queries) to the LLMs, for instance by accessing external databases or other data sources. RAG can be used to improve generated prompts by inserting the boosted data into engineered prompt templates.

### BRIEF DESCRIPTION OF THE DRAWINGS

Embodiments of the disclosure may be better understood by referencing the accompanying drawings.

FIG. 1 is a schematic diagram of an example system for offline collection of data that informs navigating a web application.

FIG. 2 is a schematic diagram of an example system for responding to a user query to navigate a web application by prompting an LLM using UI element metadata from retrieval-augmented generation.

FIG. 3 is a flowchart of example operations for maintaining an offline database of UI element metadata for a web application using a multimodal LLM.

FIG. 4 is a flowchart of example operations for responding to a user query for a web application using an engineered prompt for a LLM augmented by offline crawled UI element metadata.

FIG. 5 depicts an example computer system with an offline web application data collection system and a web application navigation query response system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Typical existing chatbots for facilitating user navigation of a web application rely on querying one or possibly multiple application programming interfaces (APIs) related to the web application. Based on data returned from the queries, these chatbots use a client-side construction of a user interface (UI) for the web application inferred from the data. To avoid this computationally expensive and error-prone process, the present disclosure proposes leveraging HyperText Markup Language (HTML) documents combined with screenshots for webpages of the web application as inputs to a first multimodal LLM for generating a database of UI element metadata. The database of UI element metadata informs prompts to a second LLM acting as a chatbot to respond to user queries for navigation of the web application.

In a first phase (“offline data preparation phase”), a web crawler crawls webpages of the web application for HTML documents or other content related to a UI of the web application. A web browser renders each webpage and generates screenshots of the renderings. The first multimodal LLM having one mode for processing text data and one mode for processing image data receives the HTML documents and screenshots in a prompt with instructions to generate database entries comprising metadata of the web application UI. The prompt can further instruct the first multimodal LLM to generate database entries of interest to each of one or more user personas. Using a multimodal LLM generalizes the data preparation beyond a specific pipeline because the multimodal LLM is able to preprocess data across user personas, domains of web applications, etc., resulting in fast and adaptable data preparation that adjusts to changes in the web applications. In a second phase (“online phase”), a database populated with the entries is used to augment prompts to a second LLM having a chatbot functionality. Based on receiving a query from a user, the database is searched for entries comprising metadata relevant to the user query. The user query, entries returned by the database, and, optionally, persona and behavioral data of the user are input to a prompt template for the second LLM. The prompt template for the second LLM comprises instructions to generate a URL(s) to present to the user for retrieving data and/or services related to the user query.

### Example Illustrations

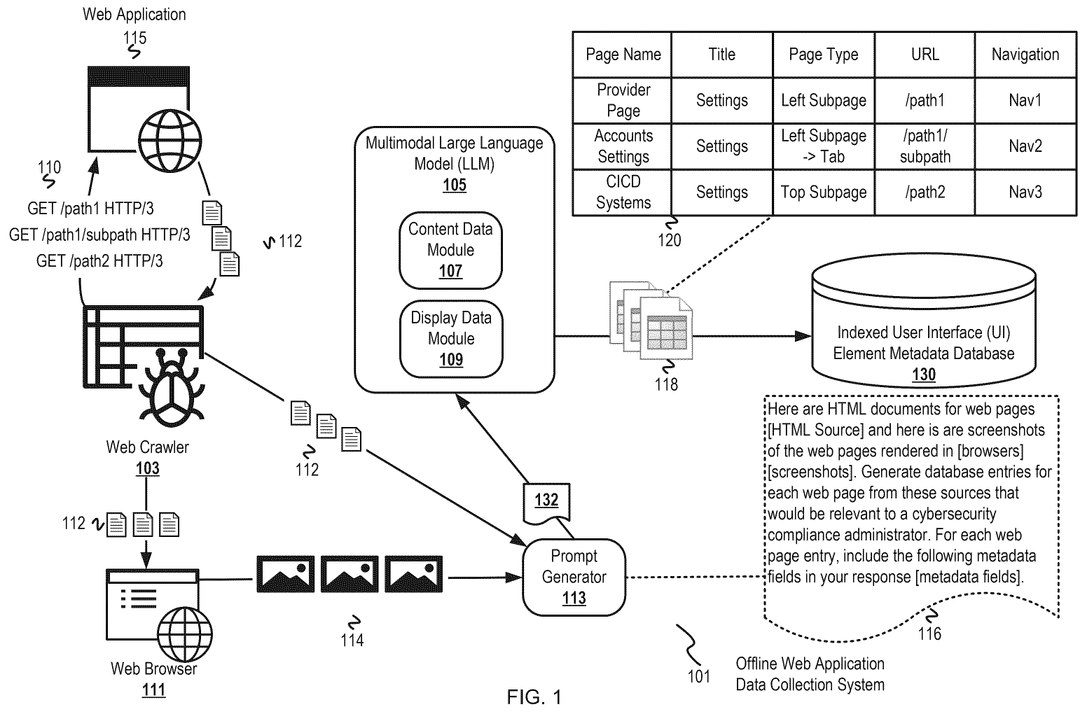

FIG. 1 is a schematic diagram of an example system for offline collection of data that informs navigating a web application. An offline web application data collection system (“system”) 101 comprises a web crawler 103 that crawls URLs of a web application 115 by communicating HyperText Transfer Protocol (HTTP) GET requests to a server of the web application 115. The web application 115 responds with HTML documents 112 that the web crawler 103 communicates to a web browser 111 and a prompt generator 113. The web browser 111 renders a screenshot(s) for each of the HTML documents 112 and communicates rendered screenshots 114 to the prompt generator 113. The prompt generator 113 generates a prompt 132 using the HTML documents 112 and the rendered screenshots 114. A multimodal LLM 105 receives the prompt 132 and generates entries 118 of an indexed UI element metadata database 130 that stores data about the web application 115. Data stored by the indexed UI element metadata database 130 augments a chatbot responding to user queries related to navigation of the web application 115.

The web crawler 103 crawls the web application 115 according to its crawling policy that can be customized for crawling of web application 115. For instance, the crawling policy can be to crawl the highest-level domain for the web application 115 and then iteratively crawl any hyperlinks contained in the current URL (e.g., with depth-first search or breadth-first search). In some embodiments, the web application 115 may correspond to multiple highest-level domains to iteratively crawl. The crawling policy can additionally be based on a sitemap file for the web application 115. A revisit policy for the web crawler 103 can be based on known updates of the web application 115. Updates and highest-level domains can be tracked by the web crawler 103, for instance via periodic application programming interface (API) calls to the web application 115 or another entity tracking the web application 115. The web crawler 103 can be configured to simultaneously crawl URLs for multiple web applications including the web application 115.

Example HTTP requests 110 communicated by the web crawler 103 to the web application 115 comprise “GET/path1 HTTP/3”, “GET/path1/subpath HTTP/3”, and “GET/path1/path2 HTTP/3”. The web crawler 103 can crawl the second of the example HTTP requests 110 based on identifying a link tag to the URL “path1/subpath” in an HTML document returned in response to the first of the example HTTP requests 110. Although depicted without query strings in FIG. 1, URLs crawled by the web crawler 103 can include URLs with query strings, for instance URLs with query strings included as hyperlinks to filter or otherwise manipulate content on web pages of the web application 115.

The web browser 111 can comprise multiple distinct web browsers (e.g., Safari®, Chrome®, and/or Firefox® web browsers) that each render the HTML documents 112 and take screenshots of the rendered documents (e.g., with a browser extension or external tool interacting with the web browsers). Each distinct web browser can render screenshots in parallel as the HTML documents 112 are received. The web crawler 103 can crawl the web application 115 with multiple HTTP requests for each URL corresponding to multiple profiles indicating different web browsers (e.g., by indicating the product and product version of the web browsers in a User-Agent header field of an HTTP request). Each of the web browsers can receive and render a subset of the HTML documents 112 resulting from crawling with the corresponding profile. The operations of the system 101 in FIG. 1 can be performed in parallel across multiple web browsers, and the entries 118 can indicate a web browser that was used to crawl/render data for the prompt generator 113 (as well as a user persona specified by the prompt 132).

Example template 116 to be used by the prompt generator 113 to generate a prompt comprises:

“Here are HTML documents for web pages [HTML Source] and here are screenshots of the web pages rendered in [browsers]: [screenshots]. Generate database entries for each web page from these sources that would be relevant to a cybersecurity compliance administrator. For each web page entry, include the following metadata fields in your response [metadata fields].”

Example metadata fields to insert into the example template 116 comprise a page name, a page title, a page type, a URL, instructions to navigate to the page, and descriptions such as descriptions of the page, actions that can be taken at the web page, and where you can go from the page. Some of the metadata fields such as page name, page title, URL, descriptions, etc. relate to content data in the HTML documents 112 whereas other metadata fields such as navigation instructions from a home page to a web page, page type, etc. relate to display data in the rendered screenshots 114. The example template 116 also specifies the cybersecurity compliance administrator user persona. The example template 116 can also comprise sitemap data provided by the web application 115 such as a sitemap file. The prompt generator 113 can have a different template for each user persona.

In addition to including the aforementioned metadata fields, the prompt 132 can further comprise instructions to identify any potential filters for each web page and include these filters in an entry for the web page. The instructions can indicate that the filters can be extracted from query parameters for crawled URLs, the HTML documents 112 and the rendered screenshots 114, for instance as dropdown menus, widgets, etc. and that the filters should be represented in a Structured Query Language (SQL) table schema or schema similar to SQL schema that can be described in the instructions with pseudo code. The LLM 105 is able to identify, from a URL and HTML document and a screenshot, any filters on the corresponding web page.

For determining certain metadata fields of a given web page, the multimodal LLM 105 may analyze multiple HTML documents/screenshots. For instance, determining navigation instructions may involve analyzing web pages at higher level URLs to identify links to the lower-level URLs. Inspecting both HTML document data and screenshot data may factor into determining the navigation instructions, for instance by identifying the link as an HTML element in the HTML document data and identifying the location of the link on the web page from screenshot data. As such, a prompt template for the prompt generator 113 may instruct the prompt generator 113 to determine the metadata fields for each web page using data across all web pages. In embodiments when the prompt 132 exceeds an input length limit for the multimodal LLM 105, the prompt generator 113 can split the prompt 132 into truncated prompts below the token limit and add indications of the multiple prompts to the instructions.

In order to understand both content data in the HTML documents 112 and display data in the rendered screenshots 114 the multimodal LLM 105 comprises a content data module 107 and a display data module 109. The multimodal LLM 105 can comprise any LLM that supports text input data and image input data (e.g., OpenAI® GPT-4). The multimodal LLM 105 can have an input component that identifies text data and image data and inputs the identified text data and image data into the content data module 107 and the display data module 109, respectively.

Example entries 120 for the indexed UI element metadata database 130 comprise:

| Page | | Page | | |
|---|---|---|---|---|
| Name | Title | Type | URL | Navigation |
| Provider | Settings | Left | /path1 | Nav1 |
| Page | | Subpage | | |
| Accounts | Settings | Left | /path1/ | Nav2 |
| Settings | | Subpage -> | subpath | |
| | | Tab | | |
| CICD | Settings | Top | /path2 | Nav3 |
| Systems | | Subpage | | |

The “Page Name”, “Title”, and “URL” fields can be inferred by the multimodal LLM 105 based on corresponding HTML documents. As described above, the “Navigation” field corresponding to navigation instructions from a home page to a web page of the web application 115 can be inferred from both screenshot data and hyperlink data in HTML documents. Example navigation instructions can comprise “Title bar->Settings-> (left nav) Providers” for the first entry, “Title bar->Settings-> (left nav) Providers-> (tab) Cloud Accounts” for the second entry, and “Title bar->Settings-> (top nav) CICD” for the third entry. The “page type” field can be inferred from navigation instructions for each of the entries. In these examples, “(left nav)” refers to navigation on a left subpage of a web page, “(top nav)” refers to navigation on a top subpage of a web page, and “(tab)” refers to selecting a tab clickable element within the webpage or subpage of the webpage. Each row in the example entries 120 corresponds to a distinct web page. Each example entry can further specify metadata such as descriptions of and content at the web page, a browser profile used to crawl the web page, and a user persona used in the prompt 132 to the multimodal LLM 105. Instructions included in the template for the prompt 132 can specify this format for the entries 118.

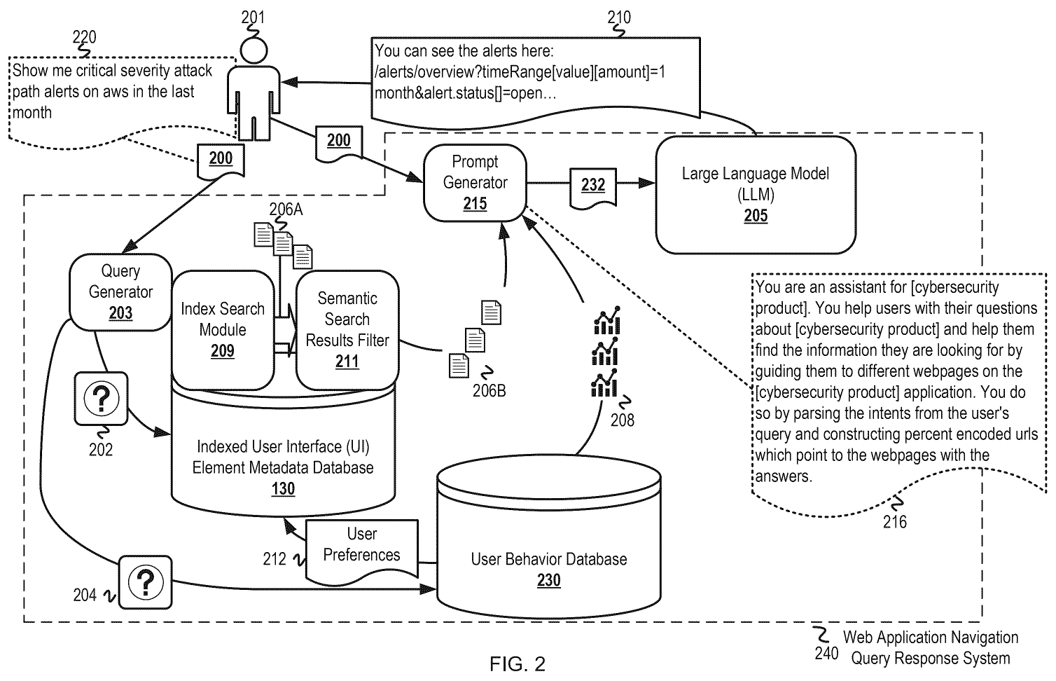

FIG. 2 is a schematic diagram of an example system for responding to a user query to navigate a web application 115 by prompting an LLM using UI element metadata from retrieval-augmented generation. A user 201 communicates a user query 200 such as example query 220 comprising the text “Show me critical severity attack path alerts on aws in the last month” to a web application navigation query response system 240. For instance, the user 201 can submit the user query 200 via a user interface integrated into a web browser at an endpoint device of the user 201. A query generator 203 receives the user query 200 and generates queries 202, 204 to the indexed UI element metadata database 130 and a user behavior database 230, respectively. The query 202 can comprise the user query 200 or an embedding(s) of the user query 200, e.g., natural language processing (NLP) embeddings generated from algorithms such as word2vec or doc2vec. The query 204 can comprise metadata of the user 201 (e.g., a persona of the user 201, identifier of the user 201, etc.) indicated by the user query 200 or an interface through which the user query 200 was submitted.

The user behavior database 230 retrieves behavioral data 208 and user preferences 212 for the user 201. The user preferences 212 comprise web page URLs (possibly including query strings to filter content at corresponding web pages) frequently accessed by the user 201. The behavioral data 208 comprises the user preferences 212 and, in some embodiments, additional data such as a persona of the user 201, activity statistics for behavior of the user 201 such as time-based behavioral statistics, etc.

The indexed UI element metadata database 130 receives the query 202 and the user preferences 212. The indexed UI element metadata database 130 comprises an index search module 209 and a semantic search results filter 211. The index search module 209 searches an index with the query 202 and/or embeddings indicated by the query 202. The index can comprise an Apache Lucene® index, an elasticsearch® index, etc. The index is searchable via metadata parameters (e.g., the metadata fields stored at entries in the indexed UI element metadata database 130) indicated by the query 202. The index search module 209 retrieves entries 206A resulting from the index search. The semantic search results filter 211 filters, from the entries 206A, those entries having low semantic similarity to the user query 200 (e.g., according to NLP embeddings of the user query 200 and the entries 206A) and/or entries not relevant to the user 201 to obtain filtered entries 206B. Each of the entries 206A can indicate an associated persona(s) and the semantic search results filter 211 can filter out those entries not associated with a persona of the user 201. Additionally, the semantic search results filter 211 can filter out entries corresponding to web page URLs not indicated in the user preferences 212. In some embodiments, the semantic search results filter 211 only filters out entries based on semantic similarity and not based on the user preferences 212.

A prompt generator 215 receives the user query 200, the filtered entries 206B, and the behavioral data 208 and generates a prompt 232 for an LLM 205 to respond to the user query 200. Example prompt 216 comprises: “You are an assistant for [cybersecurity product]. You help users with their questions about [cybersecurity product] and help them find the information they are looking for by guiding them to different webpages on the [cybersecurity product] application. You do this by parsing the intents from the user's query and constructing percent encoded urls which point to the webpages with the answers.”

Additional content to include in the example prompt 216 (omitted from FIG. 2 for conciseness) can comprise:

The [url] page hosts all the alerts generated by [cybersecurity product]. This webpage has a lot of filters to help users narrow down their searches for alerts, and help them drill down on the information they're interested in. This table contains all the fields related to each alert, such as the alert status, policy details, resource information, and other related attributes. Use cases for querying the alerts table include:
1. Listing all alerts with specific criteria, such as a particular status, policy type, or cloud account.
2. Retrieving detailed information about a specific alert by its ID.
3. Filtering alerts based on various attributes, such as policy severity, cloud region, or resource type.

The following params are supported for this url.

```
‘‘‘
viewId
ENUM(‘default’,‘highestPriority’,‘incidents’,‘attack_path’,‘exposure’,‘vulnerabilities’,‘misco
nfigurations’), -- attack_path is labeled as Risky Attack Paths
alert.id String, -- Alert id,
alert.status ENUM(‘dismissed’, ‘snoozed’, ‘open’, ‘resolved’),
time: TIMESTAMP NOT NULL,
risk_detail VARCHAR(255),
cloud.accountId VARCHAR(255), -- internal id
cloud.account VARCHAR(255), -- cloud service provider's account id
cloud.region VARCHAR(255), -- csp region
resource.id VARCHAR(255), -- cloud resource id
resource.name VARCHAR(255),
policy.name VARCHAR(255),
policy.type ENUM(‘anomaly’, ‘attack_path’, ‘audit_event’, ‘config’, ‘data’, ‘iam’, ‘network’,
‘workload_incident’, ‘workload_vulnerability’) NOT NULL,
policy.severity ENUM(‘critical’, ‘high’, ‘medium’, ‘low’, ‘informational’) NOT NULL,
policy.label VARCHAR(255),
policy.complianceStandard VARCHAR(255),
policy.complianceRequirement VARCHAR(255),
policy.complianceSection VARCHAR(255),
alertRule.name VARCHAR(255),
resource.type ENUM(‘AWS IAM User’, ‘RedLock Foreign Entity’, ‘GCP IAM external
user’, ‘EC2 Instance’, <all the supported cloud resource types>),
cloud.service VARCHAR(255),
object.exposure ENUM(‘private’, ‘public’, ‘conditional’),
malware BOOLEAN,
object.classification VARCHAR(255),
object.identifier VARCHAR(255),
timeRange.type ENUM(‘ALERT_STATUS_UPDATED’, ‘ALERT_UPDATED’,
‘ALERT_OPENED’),
vulnerability.severity ENUM(‘all’, ‘high’, ‘critical’, ‘low’, ‘medium’),
buildtime.resourceName VARCHAR(255),
git.filename VARCHAR(255),
git.provider ENUM(‘github’, ‘gitlab’, ‘bitbucket’, ‘perforce’),
git.repository VARCHAR(255),
iac.framework ENUM(‘Terraform’, ‘CloudFormation’),
asset.class VARCHAR(255),
policy.subtype ENUM(‘audit’, ‘build’, ‘data_classification’, ‘dns’, ‘identity’, ‘malware’,
‘network’, ‘network_config’, ‘network_event’, ‘permissions’, ‘run’, ‘run_and_build’, ‘ueba’),
cloud.type ENUM(‘alibaba_cloud’, ‘aws’, ‘azure’, ‘gcp’, ‘ibm’, ‘oci’, ‘other’),
policy.remediable ENUM(‘true’, ‘false’)
-- the following fields are always in a nested json
timeRange::type ENUM(“to_now”, “relative”, “absolute”)
timeRange::value ENUM( “epoch”, --only applies for timeRange-type=to_now and it
means “All Time”
  “login”, --only applies for timeRange-type=to_now and it means “Since
last login”
  “year”, --only applies for timeRange-type=relative and it means “Year to
date”
  {“amount”:“<int>”,“unit”:“hour/week/month/year”}, --only applies for
timeRange-type=relative
  {“endTime”:< epoch>,“startTime”:<epoch>} --only applies for timeRange-
type=absolute and refers to an absolute time range
‘‘‘
```

Given the following user query, construct a percent encoded url with the filters selected by the user.

This json represents how the params are before they get encoded in the url. Only the filters field is url encoded. the remaining fields are as is.

```
‘‘‘
{
  “viewId”: “default”,
  “filters”: {
    “timeRange”: {
        “type”: “to_now/relative/absolute”,
        “value”: “epoch” or “login” or {“amount”:“1”,“unit”:“week”} or {“endTime”:
time1,“startTime”: time2}
      },
    “timeRange.type”:
“ALERT_OPENED/ALERT_STATUS_UPDATED/ALERT_UPDATED”,
    “param1”: [“value1],
    “param2”: [value2],
    “param3”: [val3, val4, val5],
    “param4”: [value6]
  }
}
‘‘‘
```

Output format:

Your response should be in a markdown text format. In addition to generating the url, you should also add a line of text. Be polite, nice and try to sound like a human being. Some defaults params to be setup in the url.

The default time selection should be since last login. Default timerange.type should be ALERT_OPENED.

If the user asks for all alerts or how many alerts-pick time range=all time.

If the user mentions alert ids-pick time range=all time.

If the user doesn't specify any time range-pick since last login

If the user explicitly specifies a time range-use the user provided input. If you're not able to clearly extract the intents from the user's query, or if the question is invalid or nonsense, then respond with a polite message saying “I don't understand” Default alert.status selection should be “open”.

Be sure to validate the enum fields.

### Examples

Q: Give me all the attack path policy alerts that are magical
A: I'm sorry I don't understand
Q: Show me high sev attack path policy alerts.
A: You can see them here - [high severity attack path policy
alerts](/alerts/overview?viewId=default&filters=querystring1).
Q: Show me all the high sev attack path policy alerts.
A: You can see them here - [all high severity attack path policy
alerts](/alerts/overview?viewId=default&filters=querystring2).
Q: Show me all the high sev attack path policy alerts on AWS.
A: You can see them here - [all high severity attack path policy alerts on
AWS](/alerts/overview?viewId=default&filters=querystring3).
Q: Give me ueba anomaly alerts for gcp and azure for last 7 days
A: Here you go - [ueba anomaly alerts from gcp and azure in the past 7
days](/alerts/overview?viewId=default&filters-querystring4)
Q: I'd like to see iam policy alerts from account ‘aws-staging-123456789012’ that are >=
med severity
A: Here's a link to [medium, high and critical severity iam policy alerts from account
‘aws-staging-123456789012’](/alerts/overview?viewId=default&filters-querystring5)
Q: Show me all the misconfigurations on aws that can be fixed
A: Here you go - [all remediable misconfigurations on
AWS](/alerts/overview?viewId=misconfigurations&filters=querystring6)
Now try to do the same for the user's input
Q: {user_prompt}
A:

The above example prompt includes filters (represented in a JavaScript® Object Notation (JSON) format) from the filtered entries 206B as well as a description of the web page with URL [url] included in a content/description metadata field of one of the filtered entries 206B. The template for the prompt 232 is tailored to the web application being navigated by the user 201. In this example, the web application is a cybersecurity web application and the prompt template instructs the LLM 205 for how to handle user queries for alerts, alert identifiers, time ranges, etc. Other prompt templates for other web applications can instruct the LLM 205 for how to handle other types of frequent user queries.

Example response 210 by the LLM 205 based on prompting the LLM 205 with the prompt 232 comprises the text “You can see the alerts here: /alerts/overview?timeRange[value][amount]=1month&alert.status[ ]=open . . . ” In this example, the LLM 205 was able to identify that the timeRange filter should have value “1 month” because the user is querying for attack path alerts in the last month and that the alert.status filter should have value “open” because only open alerts are relevant to the user query 200. These filters were indicated for the webpage with URL “alerts/overview” in the prompt 232 (via filtered entries 206B).

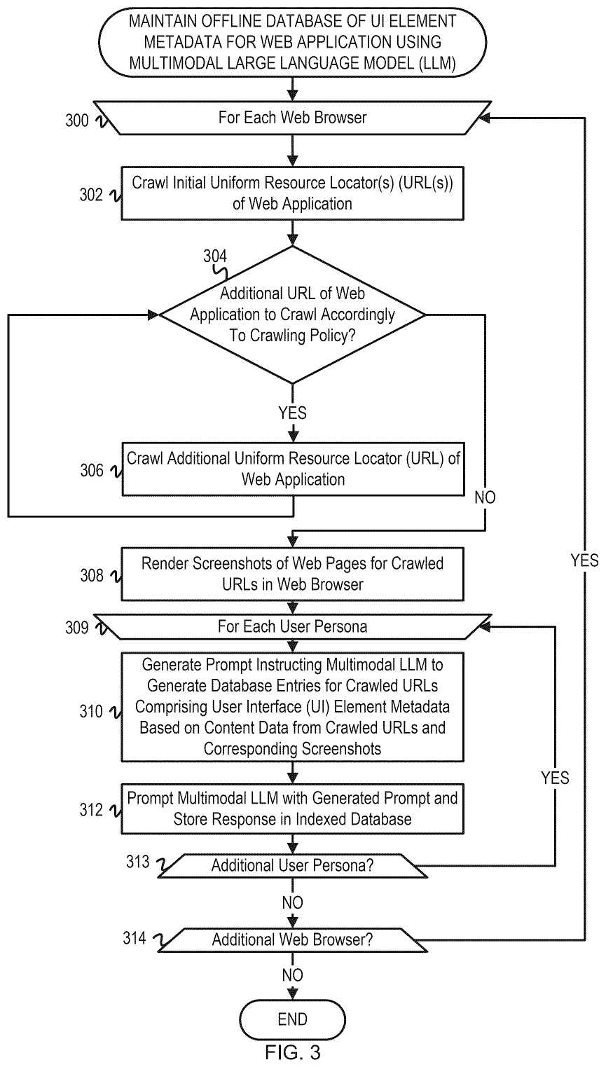

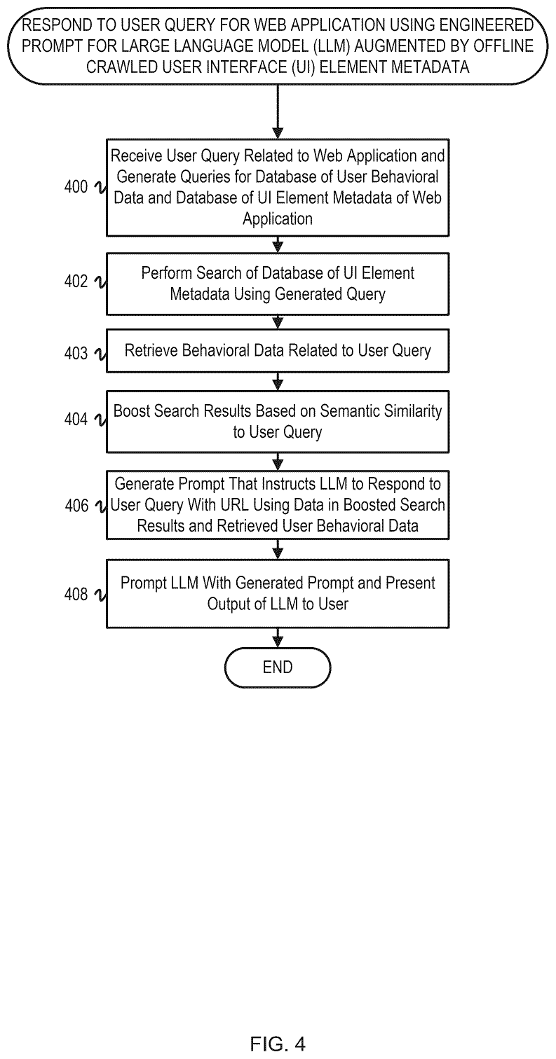

FIGS. 3 and 4 are flowcharts of example operations for offline maintenance of a database of UI element metadata for a web application with a first LLM and responding to user queries for navigation of the web application using a second LLM augmented with the database of UI element metadata. The example operations are described with reference to an offline web application data collection system (“collection system”) and a web application navigation query response system (“response system”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for maintaining an offline database of UI element metadata for a web application using a multimodal LLM. The operations in FIG. 3 involve a multimodal LLM that has an architecture able to process both text data and image data as inputs. The multimodal LLM can comprise a preprocessing component that first identifies sections of inputs comprising text data and sections of inputs comprising image data and inputs text data and image data into respective modules that can handle each data type. The multimodal LLM can be an off-the-shelf LLM trained on general language tasks with image and text data and, in some embodiments, can be fine-tuned to the context of identifying relevant UI element metadata from content (text) data and display (image) data corresponding to web pages.

At block 300, the collection system begins iterating through web browsers. The operational flow in FIG. 3 depicts the collection system crawling URLs for the web application in sequence for each web browser. Alternatively, the collection system can, at each URL to be crawled, crawl that URL using each web browser as a crawling profile.

At block 302, the collection system crawls an initial URL(s) of the web application. The initial URL can correspond to a highest-level domain for the web application, for instance as indicated in public records associated with the web application or based on domain-level knowledge by an expert familiar with the web application. In some instances, the web application may have multiple highest-level domains to crawl (e.g., when the web application supports multiple tools) and the initial URL(s) can comprise multiple URLs for each of the highest-level domains. The collection system crawls the initial URL(s) with a profile for the web browser, for instance by indicating a web browser product and product version in a User-Agent header field of an HTTP request. The collection system receives an HTTP response(s) from the crawling. In some embodiments, the HTTP response(s) can comprise a sitemap file or robots.txt file that informs a crawling policy of the collection system to crawl additional URLs.

At block 304, the collection system determines whether there is an additional URL of the web application to crawl according to the crawling policy. For instance, the collection system can inspect the HTTP response(s) from the most recently crawled URL for hyperlinks to additionally crawl. The additional URL can comprise a URL with an appended query string, for instance as indicated in a hyperlink of a web page for a previously crawled URL. If there is an additional URL of the web application to crawl, operational flow proceeds to block 306. Otherwise, operational flow proceeds to block 308. At block 306, the collection system crawls the additional URL of the web application with the profile of the web browser (for instance, as described in block 302 for the initial URL(s)) and operational flow returns to block 304 to crawl additional URLs according to the crawling policy.

At block 308, the collection system renders screenshots of web pages for crawled URLs in the web browser. Alternatively, the collection system can render screenshots of the web pages as they are crawled at blocks 302 and 304. The web browser can render screenshots of the web pages based on HTML code, JavaScript code, Cascading Style Sheets (CSS) code, etc. indicated in HTTP responses to the crawling.

At block 309, the collection system begins iterating through user personas. The user personas comprise user personas for users of an organization(s) that query for navigational assistance of the web application. For a cybersecurity organization and/or cybersecurity web application, example personas can include compliance administrator, vulnerability operator, DevSecOps, SecOps, threat hunter, chief information security officer, etc. Although FIG. 3 depicts generating a prompt for each user persona, alternatively the collection system should generate a prompt indicating that the multimodal LLM should generate an entry for each of the user personas.

At block 310, the collection system generates a prompt instructing the multimodal LLM to generate database entries for the crawled URLs comprising UI element metadata based on content data from the crawled URLs and corresponding screenshots. The content data includes HTML elements, content within each HTML element, etc. that can be supplemented by relative placement of each HTML element based on the screenshot. The prompt indicates the content data, the screenshots, relationships between content data and corresponding screenshots, and instructions to extract UI element metadata relevant to each web page and the user persona. The instructions can further indicate metadata fields such as a page name, a title, a page type, a URL, navigation instructions, filters, and content/description for the web page and/or UI elements in the web page. The instructions can include instructions for a format of the generated entries, for instance by including example entries.

At block 312, the collection system prompts the multimodal LLM with the generated prompt and stores the response in an indexed database. The database can be indexed for efficient retrieval of its entries according to various metadata fields, for instance according to an Apache Lucene index, an elasticsearch index, etc. At block 313, the collection system determines whether there is an additional user persona. If there is an additional user persona, operational flow returns to block 309. Otherwise, operational flow proceeds to block 314. At block 314, the collection system determines whether there is an additional web browser. If there is an additional web browser, operational flow returns to block 300. Otherwise, the operations in FIG. 3 are complete.

FIG. 4 is a flowchart of example operations for responding to a user query for a web application using an engineered prompt for an LLM augmented by offline crawled UI element metadata. The user query comprises a query to navigate the web application and can comprise additional constraints that impose filters on navigation of the web application. For instance, the user query can specify certain time periods, services, assets, vulnerabilities, etc. related to web application navigation for a cybersecurity related web application.

At block 400, the response system receives the user query related to the web application and generates queries for a database of user behavioral data and a database of UI element metadata of the web application. The query for user behavioral data can indicate an identifier of the user that communicated the user query, a persona of the user, etc. The query to the database of UI element metadata comprises the user query and/or embeddings of the user query or sections of the user query (e.g., tokens, sentences, etc.).

At block 402, the response system performs a search of the database of UI element metadata using the generated query. For instance, the response system can search the database according to its index using tokens, embeddings, etc. indicated by the generated query. Each entry resulting from the search corresponds to a web page for the web application and one or more personas for the user.

At block 403, the response system retrieves behavioral data related to the user query by searching the database of user behavioral data with the corresponding generated query. The retrieved behavioral data can comprise URLs frequently visited by the user, a persona of the user, filters/query strings frequently accessed by the user, etc.

At block 404, the response system boosts search results based on semantic similarity to the user query. For instance, the response system can compute distances between metadata fields in each entry to embeddings generated from the user query (e.g., using cosine similarity) and can generate scores for each entry as a sum of computed distances. The boosted search results can then be the entries with n-lowest scores (e.g., n=1, 5, etc.). Search results can further be boosted based on retrieved behavioral data by filtering, from the entries with n-lowest scores, entries not relevant to the user. For instance, each entry related to a persona(s) that is not the persona of the user can be filtered out, entries having URLs and/or query paths in URLs not indicated by behavioral data can be filtered out, entries related to content rarely accessed by the user can be filtered out, etc.

At block 406, the response system generates a prompt that instructs an LLM to respond to the user query with a URL using data in the boosted search results and the retrieved user behavioral data. The prompt comprises instructions to include filters relevant to the user query in the URL and to populate the included filters with values in the user query, for instance filters represented in a SQL table schema.

At block 408, the response system prompts the LLM with the generated prompt and presents output of the LLM to the user. For instance, the response system can present the output via a user interface (e.g., a web browser extension) of the user.

### Variations

The foregoing description refers to “prompts” of LLMs. A “prompt” can comprise any input sequence to an LLM and, in the case of multimodal LLMs, can comprise text data and image data in the input sequence. Instructions to an LLM included in a prompt can alternatively be referred to as task instructions. Content data is used in reference to HTML documents returned from web crawling and display data in reference to screenshots rendered using the HTML documents. More generally, content data can refer to any data relating to content at a web page and display data can refer to any data relating to how the web page is displayed in a UI.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIG. 3 can be performed in parallel or concurrently across web browsers and user personas. Crawling with multiple web browsers in FIG. 3 is not necessary. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

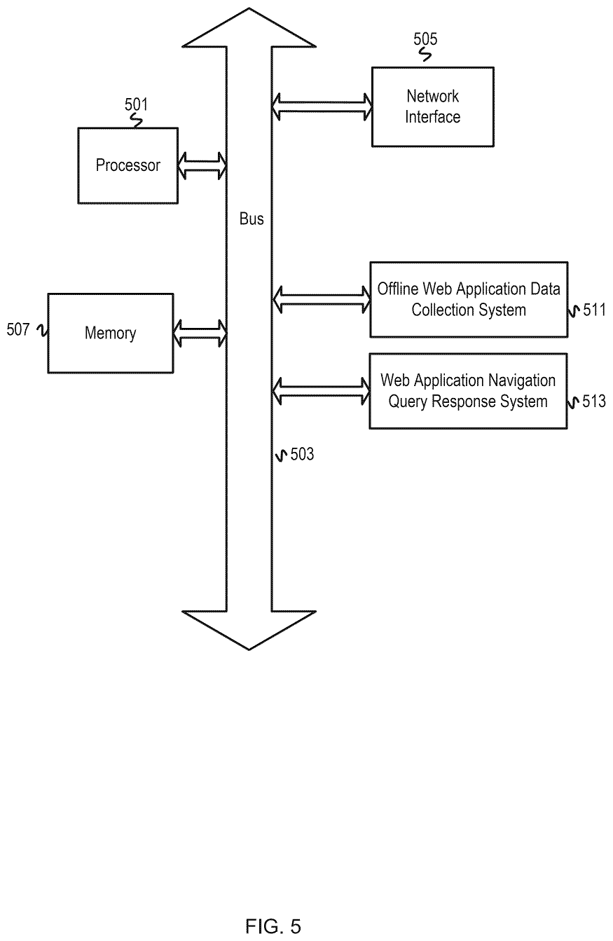

FIG. 5 depicts an example computer system with an offline web application data collection system and a web application navigation query response system. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes an offline web application data collection system (collection system) 511 and a web application navigation query response system (response system) 513. The collection system 511 comprises an offline data preparation pipeline that crawls web pages of a web application for HTML documents of web pages of the web application. The collection system 511 renders screenshots of the crawled webpages and prompts a multimodal LLM with instructions to generate entries of UI element metadata for a database for each web page using the HTML documents and rendered screenshots. The response system 513 receives user queries to navigate the web application and prompts an LLM to respond to the user queries with URLs. The response system 513 augments the prompts to the LLM with UI element metadata stored in the database. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.) The processor 501 and the network interface 505 are coupled to the bus 503. Although illustrated as being coupled to the bus 503, the memory 507 may be coupled to the processor 501.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
crawling first uniform resource locators (URLs) for one or more web pages of a web application to retrieve at least one of display data and content data for the one or more web pages;
prompting a first language model with a first input sequence to obtain metadata of user interface (UI) elements for the one or more web pages as output, wherein the first input sequence indicates at least one of the display data and the content data;
storing the metadata of UI elements indexed by metadata parameters indicated in the metadata of UI elements; and
based on receiving a query from a user for content of the web application, augmenting a second input sequence to a second language model with a subset of the metadata of UI elements relevant to the query from the user, wherein the second input sequence comprises the subset of the metadata of UI elements and task instructions to the second language model to respond to the user.

2. The method of claim 1, wherein the task instructions to the second language model comprise task instructions to identify second URLs that navigate to information responsive to the query from the user.

3. The method of claim 2, wherein the task instructions to the second language model further comprise task instructions to add and populate filters to one or more of the first URLs to obtain the second URLs, wherein the task instructions for populating filters comprise task instructions for populating the filters with values in the query from the user.

4. The method of claim 1, further comprising identifying the subset of the metadata of UI elements relevant to the query from the user, wherein identifying the subset of the metadata of UI elements comprises,
identifying first metadata from the stored metadata of UI elements based on matching metadata parameters indexed in storage with parameters indicated in the query from the user; and
identifying the subset of the metadata of UI elements based on semantic similarity between the first metadata and the query from the user.

5. The method of claim 4, wherein identifying the subset of the metadata of UI elements similar to the query from the user is further based on similarity of characteristics of the user and characteristics of behavior of the user for the web application and the stored metadata of UI elements.

6. The method of claim 1, further comprising,
prompting the second language model with the second input sequence to obtain a response as output; and
presenting the response to the user.

7. The method of claim 1, wherein the metadata of UI elements comprise at least one of web page names, web page titles, web page types, URLs, web page navigation task instructions, web page filters, and at least one of UI element descriptions and UI element content.

8. The method of claim 1, wherein the content data comprises HyperText Markup Language (HTML) documents for the one or more web pages, and wherein the display data comprises screenshots of web browser renderings for the one or more web pages.

9. The method of claim 1, wherein the first language model comprises a multimodal large language model having a first mode that takes the display data as input and a second mode that takes the content data as input.

10. The method of claim 1, wherein the second language model comprises a large language model.

11. A non-transitory machine-readable medium having program code stored thereon, the program code comprising instructions to:
crawl first uniform resource locators (URLs) for one or more web pages of a web application to retrieve at least one of display data and content data for the one or more web pages;
prompt a first language model with a first input sequence to obtain metadata of user interface (UI) elements for the one or more web pages as output, wherein the first input sequence indicates the at least one of display data and the content data;
store the metadata of UI elements indexed by metadata parameters indicated in the metadata of UI elements; and
based on receiving a query from a user for content of the web application, augment a second input sequence to a second language model with a subset of the metadata of UI elements relevant to the query from the user, wherein the second input sequence comprises the subset of the metadata of UI elements and task instructions to the second language model to respond to the user.

12. The non-transitory machine-readable medium of claim 11, wherein the task instructions to the second language model comprise task instructions to identify second URLs that navigate to information responsive to the query from the user.

13. The non-transitory machine-readable medium of claim 12, wherein the task instructions to the second language model further comprise task instructions to add and populate filters to one or more of the first URLs to obtain the second URLs, wherein the task instructions for populating filters comprise task instructions for populating the filters with values in the query from the user.

14. The non-transitory machine-readable medium of claim 11, wherein the program code further comprises instructions to identify the subset of the metadata of UI elements relevant to the query from the user, wherein the program code to identify the subset of the metadata of UI elements comprises instructions to,
identify first metadata from the stored metadata of UI elements based on matching metadata parameters indexed in storage with parameters indicated in the query from the user; and
identify the subset of the metadata of UI elements based on semantic similarity between the first metadata and the query from the user.

15. The non-transitory machine-readable medium of claim 11, wherein the program code further comprises instructions to,
prompt the second language model with the second input sequence to obtain a response as output; and
present the response to the user.

16. An apparatus comprising:
a processor; and
a machine-readable medium having instructions stored thereon that are executable by the processor to cause the apparatus to,
maintain metadata of user interface (UI) elements of a web application, wherein the instructions to maintain the metadata of UI elements comprise instructions executable by the processor to cause the apparatus to,
periodically crawl first uniform resource locators (URLs) of the web application for display data and content data;
prompt a first language model with a first input sequence to obtain metadata of user interface (UI) elements in web pages of the web application as output, wherein the first input sequence indicates at least one of the display data and the content data; and
store the metadata of UI elements indexed by parameters for filtering content of the web application; and
based on receiving a query from a user requesting content from the web application, augment a second input sequence to a second language model with a subset of the stored metadata of UI elements relevant to the query, wherein the second input sequence wherein the second input sequence comprises the subset of the metadata of UI elements and task instructions to the second language model to respond to the user.

17. The apparatus of claim 16, wherein the task instructions to the second language model comprise task instructions to identify second URLs that navigate to information responsive to the query from the user.

18. The apparatus of claim 17, wherein the task instructions to the second language model further comprise task instructions to add and populate filters to one or more of the first URLs to obtain the second URLs, wherein the task instructions for populating filters comprise task instructions for populating the filters with values in the query from the user.

19. The apparatus of claim 16, wherein the machine-readable medium further has stored thereon instructions executable by the processor to cause the apparatus to identify the subset of the stored metadata of UI elements relevant to the query from the user, wherein the instructions to identify the subset of the stored metadata of UI elements comprise instructions executable by the processor to cause the apparatus to,
identify first metadata from the stored metadata of UI elements based on matching metadata parameters indexed in storage with parameters indicated in the query from the user; and
identify the subset of the stored metadata of UI elements based on semantic similarity between the first metadata and the query from the user.

20. The apparatus of claim 16, wherein the machine-readable medium further has stored thereon instructions executable by the processor to cause the apparatus to,
prompt the second language model with the second input sequence to obtain a response as output; and
present the response to the user.
